(19) United States
(12) Patent Application Publication
(10) Pub. No.: US 2024/0415721 A1
(43) Pub. Date: Dec. 19, 2024

(54) ANKLE-FOOT ORTHOSIS

(71) Applicant: The Board of Trustees of the University of Illinois, Urbana, IL (US)

(72) Inventors: Michael Jacobson, Chicago, IL (US); Prakyath Kantharaju, Chicago, IL (US); Inigo Sanz Pena, Chicago, IL (US); Hyeongkeun Jeong, Chicago, IL (US); Myunghee Kim, Chicago, IL (US)

(21) Appl. No.: 18/743,523

(22) Filed: Jun. 14, 2024

Related U.S. Application Data
(60) Provisional application No. 63/521,023, filed on Jun. 14, 2023.

(51) Int. Cl. A61H 3/00; A61H 1/02; A63B 22/02

(52) U.S. Cl. CPC A61H 3/00; A61H 1/0266; A63B 22/025; A61H 2201/018; A61H 2201/1215; A61H 2201/165; A61H 2201/169; A61H 2201/5007; A61H 2201/5061; A61H 2201/5069; A61H 2201/5071; A61H 2230/405

(57) ABSTRACT

The present disclosure relates to ankle-foot orthosis systems and methods. One such system comprises an ankle-foot orthosis wearable device having a split-toe plate design comprising dual unidirectional actuation, wherein the split-toe plate design comprises a left and right toe plates; an off-board actuator system configured to independently move the left and right toe plates, wherein the off-board actuator system is in mechanical communication with the ankle-foot orthosis wearable device via mechanical cables; and a controller hardware device configured to deliver control signals to the off-board actuator system and correct a plantarflexion or inversion-eversion torque of a human ankle in real time during an activity session based on activity skill levels analyzed via the off-board controller hardware device and data received from ankle angle sensors or the load cell sensors at an earlier time. The present disclosure further includes systems and methods for a personalization framework for wearable robots.

### CROSS-REFERENCE TO RELATED APPLICATION

This application claims priority to co-pending U.S. provisional application entitled, “Ankle-Foot Orthosis (AFO),” having Ser. No. 63/521,023, filed Jun. 14, 2023, which is entirely incorporated herein by reference.

### BACKGROUND

Over the last 30 years, diseases affecting the mobility of adult groups above 50 years old were among the ten with the most increases in disability-adjusted life years (DALYs). Motor disabilities can result in walking alterations and motor impairments. Musculoskeletal disorders, stroke, and diabetes are the most common cause of limited mobility in people living alone. Gait rehabilitation aims to improve function and regain mobility through physical therapy, including over-ground assisted walking, body-weight-supported training, and gait treadmill training, which can improve walking speed and endurance in chronic stroke survivors with the ability to walk independently. However, physical therapy resources are often limited and sometimes unsuitable to the patient's walking dependency, rehabilitation intensity, and frequency requirements.

Wearable assistive robots are a technology to aid physical therapy methods for gait training that can reduce the effort of therapists and improve personalizing the rehabilitation. Robot-assisted Gait Training can improve balance and independence in daily activities, lower limb function, and increase walking speed. However, to address each individual's unique needs, personalized robots are necessary.

### BRIEF DESCRIPTION OF THE DRAWINGS

Many aspects of the present disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIGS. 1 and 2 show an exemplary modular robotic ankle-foot orthosis wearable device with active plantarflexion and in/eversion supports in accordance with various embodiments of the present disclosure.

FIG. 3 shows an exemplary ankle-foot orthosis system in accordance with various embodiments of the present disclosure.

FIG. 4 shows an exemplary portable ankle-foot orthosis system in accordance with various embodiments of the present disclosure.

FIG. 5 shows a subject wearing an exemplary ankle-foot orthosis wearable device with moment and force components for plantarflexion and in/eversion assistance being denoted in accordance with various embodiments of the present disclosure.

FIG. 6 shows an exemplary personalization framework for personalizing control parameters of wearable robotic system, such as an orthosis system, using physiological or biofeedback responses in accordance with various embodiments of the present disclosure.

FIG. 7 shows an exemplary algorithm for performing aspects of the Bayesian optimization step of the personalization framework of FIG. 6.

FIG. 8 illustrates the personalization framework of FIG. 6 in the context of performing ankle foot exoskeleton personalization in accordance with various embodiments of the present disclosure.

FIG. 9A illustrates a two-day protocol used to personalize assistance using the personalization framework of FIG. 8.

FIG. 9B shows the metabolic costs observed during a validation condition for the test trial performed in FIGS. 8 and 9A.

FIG. 10 shows a schematic block diagram of a computing device that can be used to implement various embodiments of the present disclosure.

### DETAILED DESCRIPTION

The present disclosure describes various embodiments of personalized robotic ankle-foot orthoses (AFO) and related methods. Wearable robots, in particular, robotic ankle-foot orthoses (AFO), have been used in gait assistance and rehabilitation in adults with disabilities affecting mobility. The use of assistive technologies provides personalization of the rehabilitation based on the patient's characteristics and conditions. Personalization of wearable robots has been mainly centered around investigating subject-specific assistance control strategies using biofeedback to adapt to the high intersubject variability and balance-related effort, resulting in improved energy efficiency. Personalizing the mechanical design in wearable robots is also essential to accommodate anthropometry and gait biomechanics, considering the device functionality based on the user's condition and gait training aims. Besides the current approaches to personalize the assistance control, there is a need to define a practical design to prescribe personalized exoskeletons for each user, considering inter-subject variability of anthropometry measures, ankle joint biomechanics and stiffness, and condition-related gait characteristics. Modular wearable designs can be easily adapted to match the wearer's anthropometry and could be a versatile approach to increase the personalization capabilities, while Human-In-the-Loop (HIL) optimization techniques using physiological or biofeedback responses can personalize and optimize the benefits of rehabilitation and/or training regimes using such assistive devices.

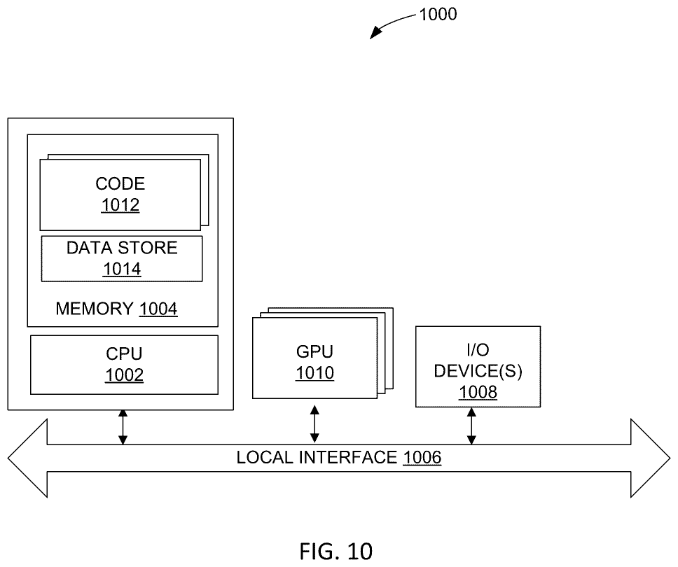

In accordance with the present disclosure, advances in material composites and accessibility of additive manufacturing (AM) technologies allow for the creation of assistive devices that resist high stresses and are lightweight. The use of AM carbon fiber composites (e.g., carbon fiber reinforced nylon, nylon 12 carbon fiber (CF), etc.) presents an alternative to heavy duty metal-based wearable robots, reducing the payload and improving sustainability of designs. An important aspect in the design of wearable robots, in particular exoskeletons is the mimic of the human body degrees of freedom. Systems and methods of the present disclosure utilize compliant structures that mimic the ankle joint degrees of freedom. In various embodiments, an exemplary ankle-foot orthosis wearable device 100 comprises a hybrid material of rigid metal and soft rubber configured to minimize movement impediment due to a weight of the ankle exoskeleton while maintaining a wide torque range for control. In various embodiments, anthropometric measurements for a particular user can be input into the printable components of a computing device (FIG. 10) in order to personalize and match the user's characteristics in the measurements to the printable components for the AFO wearable device 100.

Consider that aging affects ankle strength and range of motion, resulting in loss of stability, reduced ankle plantarflexion strength, and decreased eversion range of motion. Several risk factors, including muscular weakness, loss of balance control, gait abnormality, and dementia, are linked to falls in the elderly. The ankle torque strength and range of motion can affect balance. Ankle eversion taping can improve static and dynamic balance, and in/eversion assistance has reduced effort associated with balance in individuals with below-knee amputation. The in/eversion assistance in a robotic AFO can improve muscle strength, promote a more comprehensive gait rehabilitation, including balance, and mitigate injury risk. Implementing ankle in/eversion assistance in AFO can increase the capabilities of wearable robots during gait rehabilitation and training of elderly populations.

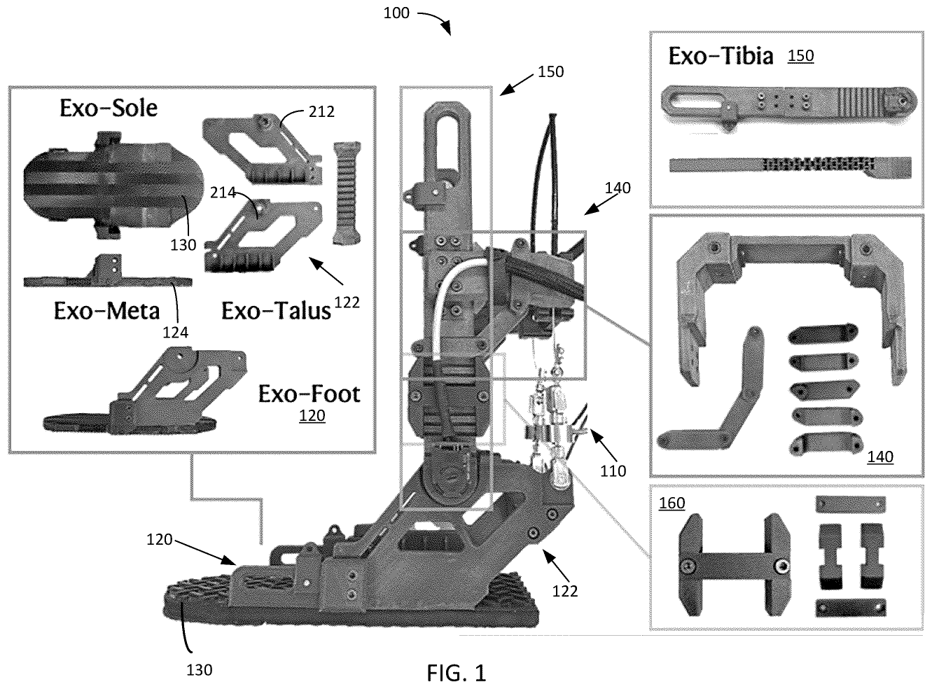

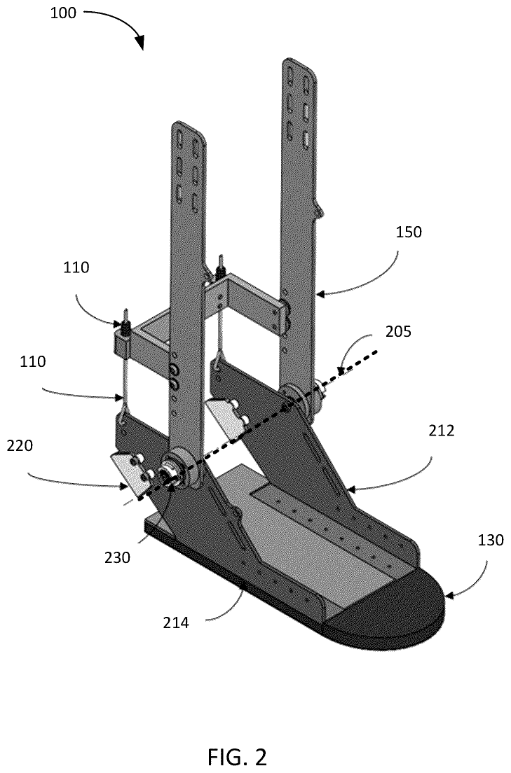

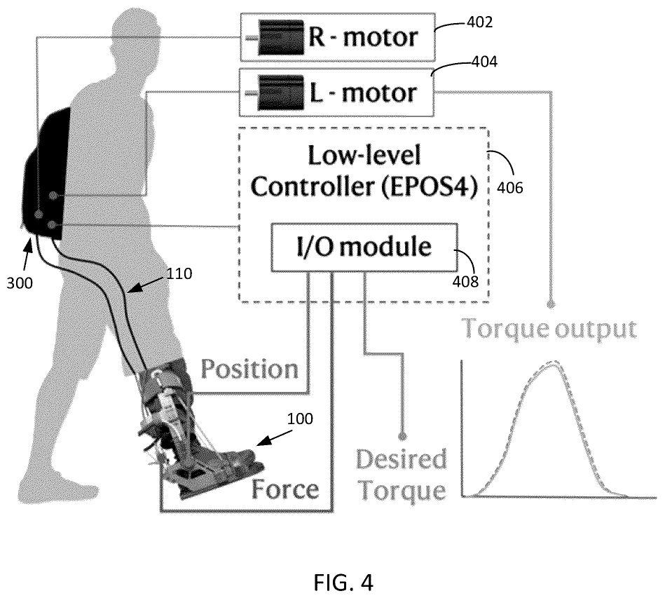

FIG. 1 shows an exemplary modular robotic AFO wearable device 100 with active plantarflexion and in/eversion supports. In various embodiment, the device 100 may be fabricated using additive manufacturing. In various embodiments, maximum plantarflexion and dorsiflexion ranges are 25° and 40°, respectively. A dual cable-transmission portable system 110 is provided for plantarflexion and in/eversion assistance. Actuation for the plantarflexion and in/eversion assistance is performed using two independent cable-pulling transmissions 110 driven by electric motors attached to the AFO wearable device's foot component (Exo-Talus) 120 on the medial and lateral sides. In various embodiments, Bowden cables are used to exert transmitted torque to the AFO wearable device for movement. An actuator unit 304 (FIG. 3) actuates toe components independently for plantarflexion and inversion-eversion. In various embodiments, passive dorsiflexion is provided using two elastic rubber bands 510 (FIG. 5).

The modular AFO wearable device 100 comprises four sub-assemblies. The subassembly corresponding to the AFO's foot (Exo-Foot) 120 is composed of two main components, the Exo-Talus 122 and the Exo-Meta 124 (e.g., connected using bolted joints). In various embodiments, the medial and lateral components are joined through a rubber sole (Exo-Sole) 130 of medium stiffness that can be easily replaced to fit different shoe sizes. On the posterior side, a transversal component 140 is used to connect both sides), providing high compression stiffness in the medial-lateral direction while allowing the in/eversion compliance of the device. At the AFO ankle joint, an Exo-Tibia assembly 150 is coupled using a hinge joint. The Exo-Tibia assembly 150 holds a strap or spur attaching the AFO wearable device 100 to a subject's leg. Stiffness components 160 increase stiffness in the sagittal plane while allowing a range of motion in the frontal plane of the AFO wearable device 100.

In various embodiments, the attachment of the AFO wearable device 100 to the subject's leg is performed using a strap located at the anterior tibialis. To maximize the assistive torque transmitted to the subject while maximizing comfort, the device 100 is attached to the subject's leg at ⅓rd of the tibia distance from the anterior origin, coincident with the most anterior part of the tibialis anterior and avoiding the interface of the Exo-Tibia assembly 150 with the knee. Cushioned protection may be used on the anterior, posterior, medial, and lateral sides of the tibia, maintaining the Exo-Tibia 150 straight when attached to the subject.

The Exo-Foot component 120 can be personalized for different shoe sizes, varying the length of the Exo-Meta 124 and Exo-Sole 130 components and the width of the Exo-Sole component 130. As shown in FIG. 2, in various embodiments, the AFO wearable design 100 has two independently actuated toe plates (formed by the Exo-Talus 122 components) that rotate about a joint axis 205 approximating the human ankle joint which allow for two degrees of freedom. The toe plates include a medial toe plate 212 and a lateral toe plate 214 in a split toe design. The AFO wearable device 100 having the split toe design is proven to improve balance by controlling ankle inversion-eversion torque in walking and/or squatting activities for individuals.

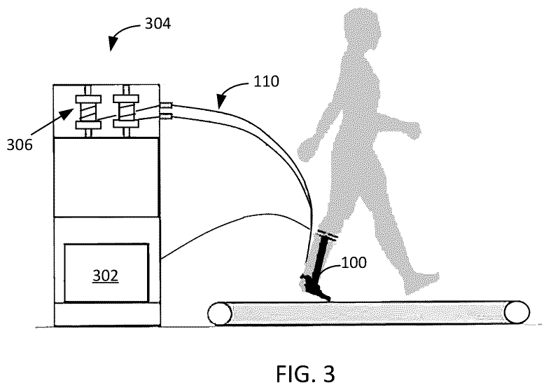

As shown in FIG. 3, in various embodiments, the AFO wearable device 100 comprises a tethered end effector which controls inversion-eversion torque by utilizing an off-board control hardware 302 and actuation system 304. In separating the end effector from control hardware and actuation system 302, 304, the challenges from developing a fully autonomous system may be dissociated to improve mechatronic performance. In an embodiment, the AFO wearable device 100 controls inversion-eversion within a range of −20° to 20° relative to the prosthesis neutral position and generates inversion-eversion torque of approximately −20 to 20 N-m. While FIG. 3 shows the offboard control and actuator systems 302, 304 in a stationary arrangement, some embodiments of the present disclosure provide a portable offboard control and actuator systems 300 that can be carried by a user in a backpack (or other type of garment) that is being worn by the user, as shown in FIG. 4.

In FIG. 4, as a pulley 306 rotates from the actuator unit 304, the conduit of the Bowden cables 110 can exert an equal and opposite reaction as to reduce any net force experienced by the end-effector 100 itself. The inner cables of the Bowden cables 110 can then pull upward on the posterior aspect of each toe plate of the AFO wearable device 100 as the opposite end contacts the ground to generate a moment. This moment results in plantarflexion of the AFO wearable device 100. Also, during swing phase while torque from the actuator unit 304 is at a minimum, rubber bands 510 can act to dorsiflex each toe (as shown in FIG. 5).

In various embodiments, a stationary offboard actuator unit 304 contains two Humotech Caplex Actuators and the control hardware 302 includes a Humotech I/O unit, and a Speedgoat Performance Real-Time Target Machine. The Humotech I/O unit is configured to receive sensor data (via an electrical cable or wireless communications) which can then be processed through the Speedgoat machine in conjunction with Simulink Real-Time software to deploy control methods to drive each of the actuators. In various embodiments, each actuator can generate a maximum motor torque of 125 Nm and maximum motor speed of 2495 rpm. In various embodiments, a portable control unit and actuator unit (as utilized in FIG. 4) includes a hardware control unit 302, an actuation unit 304, and a battery unit. In various embodiments, a weight of the portable control unit and actuator system is approximately 6.5 kg.

In accordance with various embodiments of the present disclosure, torque and angle data are obtained by sensors to produce ankle-foot orthosis movement. For example, in some embodiments, magnetic encoders 230 (FIG. 4) (e.g., U.S. Digital MAE-5 Encoders) may be used to sense angle variation of toe plates with a magnet which is press fit to revolute shafts of the Exo-Tibia assembly 150. In various embodiments, exemplary encoder parameters include a 10-bit resolution with a PWM frequency of 0.975 kHz (or approximately 0.975 kHz) and an internal sampling rate of 10.42 kHz (or approximately 10.42 kHz). In various embodiments, for torque sensing, two tension load cells 220 (e.g., DYMH-103 tension load cells) are attached to the toe plates by frictionless pins and attached in line with the inner Bowden cable 110 (as represented in FIG. 2). Also, in some embodiments, a strain gauge analog amplifier (e.g., Futek IAI00) is integrated for each toe as to ensure 10 VDC output, and to account for environmental disturbances, sensors are protected by fused deposition modeled enclosures. Any suitable material and manufacturing method can be used to form devices in accordance with the principles herein. For example, 3D-printed materials such as carbon pieces can be used to form exoskeleton frame components for the AFO wearable device 100. Other materials and methods are contemplated as well.

In walking, moments generated about the sagittal plane due to plantarflexor muscle contraction account for 93% of work performed at the ankle joint. Thus, inversion-eversion torque values during walking are substantially lower in comparison which leads to the feasible application of a split-toe design by coupling plantarflexion and inversion-eversion torque. The split-toe design alleviates the need for bidirectional Bowden cable actuation by introducing a dual unidirectional actuation approach. Furthermore, unidirectional actuation eliminates friction and random forces which occur from the preload required to eliminate backlash in bidirectional actuation.

The motion generated by the AFO wearable device 100 allows for plantar-dorsiflexion and inversion-eversion. The device 100 generates torque and movement in both plantarflexion and inversion-eversion directions using the two independent toe plates. The toe plates share a single axis of rotation and rotate independently at the ankle joints. Plantarflexion occurs when both toe plates rotate in the same direction, and inversion-eversion occurs when they rotate in opposite directions, where plantarflexion angle is defined as the average of the toe angle plates and inversion-eversion angle as the difference between the two toe angle plates multiplied by the ratio of toe length to half the foot width. Thus, plantarflexion torque, τ_{pf} is defined as the sum of the lateral and medial toe torques, τₗ and τₘ, while inversion torque, τᵢₙᵥ, is defined as the difference between the lateral and medial toe torques multiplied by the ratio of half the orthosis width,

$$\frac{1}{2} w ,$$

to toe length, l, or

$${τ}_{pf} = {τ}_{l} + {τ}_{m} \qquad ( 1 )$$

$${τ}_{inv} = \frac{w}{2 l} ( {τ}_{l} - {τ}_{m} ) .$$

Definitions of plantarflexion and inversion-eversion torque used herein are consistent with biomechanics nomenclature. These definitions also allow for decreased data collection nodes by having a single torque sensing device (e.g., load cell 220 in FIG. 2) per toe plate 212, 214. Alternate torque definitions would require additional sensing capabilities. Defining torques in the ground reference frame, for example, would also require the measurement of axial and mediolateral toe forces, as well as the absolute orientation of the orthosis.

This torque definition makes the approximation that the contact point of the toe plate is centered on the anterior vertex of the toe. Small differences in effective contact point can occur during walking, for example, if the ankle is substantially everted and the device rolls onto one edge. However, toe width is small compared to foot width and the toe plate 212, 214 rests on a sole 130 consisting of soft material, both of which limit the mediolateral displacement of the center of pressure of the toe contact. Inaccuracies in measuring inversion-eversion moment in the orthosis reference frame are, therefore, expected to be small.

The main components located at the AFO for the assistance control and transmission of the forces as well as the torques notation, are represented in FIG. 5. In particular, the left side of FIG. 5 shows a subject wearing the AFO wearable device on their right leg, with the middle and right portions of FIG. 5 representing the moment arms, and force control components for plantarflexion and in/eversion assistance, respectively.

The plantarflexion torque M_{pf} is defined as the sum of the left and right toe plate torques. Similarly, the in/eversion torque Mᵢₙ₋ₑᵥ is defined as the difference between the left and right toe plate torque multiplied by a constant defined by the geometry of the AFO wearable device 100 as specified in FIG. 5 and illustrated by Equations (2):

$${M}_{pf} = {M}_{L} + {M}_{R} \qquad ( 2 )$$

$${M}_{i n - ev} = ( {M}_{L} - {M}_{R} ) \cdot \frac{{w}_{ankle}}{2 {d}_{ankle}}$$

In some embodiments, instead of or in addition to magnetic encoders, the AFO wearable device 100 utilizes ankle angle sensors 230 in the form of two incremental optical encoders (e.g., Broadcom HEDS-5500-A06) that are mounted to the frame and measure the joint angle in the sagittal plane. The assistive torques are controlled using the feedback from two tensile load cells 220 (e.g., DYMH-103). In various embodiments, the actuator system 304 includes two EC i-52 motors (Maxon Group, Switzerland). The control unit 302 (e.g., Simulink real-time controller) commands the AFO output torque and motor drivers (e.g., EPOS4 50/15 EtherCAT motor drivers (Maxon Group, Switzerland)) are used to actuate the motors and read the position and force feedback signals. Further, in various embodiments, two snap-acting subminiature limit switches are installed on the medial and lateral sides of the AFO wearable device 100 to control the maximum plantarflexion angle for safety.

To route the cable-transmission steel wires, in various embodiments, Bowden cables with a length of approximately 2 m and a diameter of 5 mm are used to carry off-board emulator testing. The cable may connect to the posterior side of the AFO's Exo-Talus by means of a clevis rod. During squatting activity, the reaction forces from the Bowden cables, which attach to the AFO wearable device 100 on the posterior side of the Exo-Tibia assembly 150, transmit the squatting torque to the subject's leg. An exemplary schematic of the controller hardware 302 used to perform and control the robotic assistance is shown in FIG. 4. Here, the actuator include right and left motors 402, 404 and the controller hardware 302 includes a low-level controller module 406 and an I/O module 408.

To control the assistive torques as defined in Equations 2, the controller hardware 302 is configured to execute a proportional control method to control the ankle torque and ankle position. In various embodiments, the controller hardware 302 determines an actuation command signal and motor velocity by multiplying the proportional control gain by the difference between a reference and measured signal. The actuation signals are then sent as a command to a motor 402, 404 to rotate with the desired velocity, and the ankle angle sensors 230 on the exoskeleton measure and send the actual ankle torque and/or ankle position to the controller hardware 302.

The desired motor velocity parameter \dot{θ}_{d} is determined by Equation (3), where k_{gain} is the proportional gain of the torque error, M_{d} is the desired torque, and Mₘ is the measured torque using feedback from the load cell 220. In various embodiments, the controller hardware 302 executes Simulink software (Mathworks) and operates at 1 KHz.

$${θ}_{d} = {k}_{gain} ( {M}_{d} - {M}_{m} ) \qquad ( 3 )$$

In various embodiments, squat assistive torque profiles are discretized for the descent and ascent squatting phases. Exemplary torque/angle profiles can be determined by the multiplication of a stiffness gain parameter and the ankle angle parameter. In various embodiments, the maximum torque during the ascending phase is set at 30° degree dorsiflexion ankle angle. Then, the stiffness of descending squat can be determined as a 15 Nm of plantarflexion torque at 30° degree dorsiflexion ankle angle by referring to the torque boundary. In various embodiments, for the in/eversion conditions, the maximum plantar flexion torques of the left and right sides is set to 20 Nm and 6 Nm, maintaining a difference of 14 Nm between each side to achieve a 10 Nm in/eversion torque.

For walking control, an exemplary controller 302 utilizes a low-level and a mid-level control process, where the low-level control process is similar to that described for the squatting activities in that the low-level control process uses proportional control to determine desired motor position, motor velocity, ankle position, and ankle torque command signals.

Correspondingly, in various embodiments, the mid-level control process involves gait mechanics, where gait phases are detected using foot-contact switches (heel and toe), ankle torque, and ankle velocity measurements. In an exemplary control process, the gait phase is divided into two sub-phases: swing and stance phases. During the swing phase, ankle-angle position control is conducted, and during the stance phase, torque control is performed. In various embodiments, the swing phase is detected when a measured ankle torque is below a maximum torque threshold, an ankle-angle is higher than a minimum angle threshold, and both foot switches are off. In turn, the stance phase is detected when the measured ankle torque is higher than a minimum torque threshold, the ankle-angle is below a maximum angle threshold, and the heel switch is triggered or the ankle angular velocity is zero.

In the mid-level control process, the controller 302 is configured to generate an ankle-angle torque curve using a parameter set named shape dorsi, max torque, and max dorsi angle. The shape dorsi parameter is a control point of the quadratic bezier torque curve such that changing the shape dorsi parameter can change the shape of the ankle-angle torque curve. Additionally, changing the max dorsi angle parameter changes the steepness of the curve. Accordingly, the controller 302 can determine a desired ankle torque, in stance phase, from the bezier torque curve proportional to the ankle-angle, where for the desired inversion-eversion torque, it was a constant parameter value. Then, torque for the right toe and for the left toe can be calculated with the following formula, where l represents the toe plate length and w represents the toe plate width:

$${τ}_{left} = \frac{1}{2} {τ}_{pf} + \frac{l}{w} {τ}_{inv} \qquad ( 3 )$$

$${τ}_{right} = \frac{1}{2} {τ}_{pf} - \frac{l}{w} {τ}_{inv} \qquad ( 4 )$$

In addition to configuring gait mechanics, exemplary methods of the present disclosure are also directed to personalizing assistance methods to meet each user's needs. One such personalization method is a data-driven approach known as Human-in-the-loop (HIL) optimization. In general, HIL optimization often uses a physiological or kinematic measure to increase the effectiveness of wearable robots in decreasing user's physical effort during various activities, such as walking. However, such optimization and cost estimation methods typically involve custom optimization setup. In addition, they typically require significant tuning and reprogramming of the communication system between the optimization outcomes and wearable robots. This variability and tuning increase the barrier to entry for exoskeleton (and prosthetic) personalization.

However, in accordance with various embodiments, systems and methods of the present disclosure utilize an exemplary HIL personalization framework with a communication protocol-lab-streaming layer (LSL). Accordingly, LSL is a TCP-based network communication protocol that has been implemented in various physiological sensors as it allows near-real-time access to time series information and synchronization. This type of setup is modular and is capable of configuring the cost function and optimization methodologies.

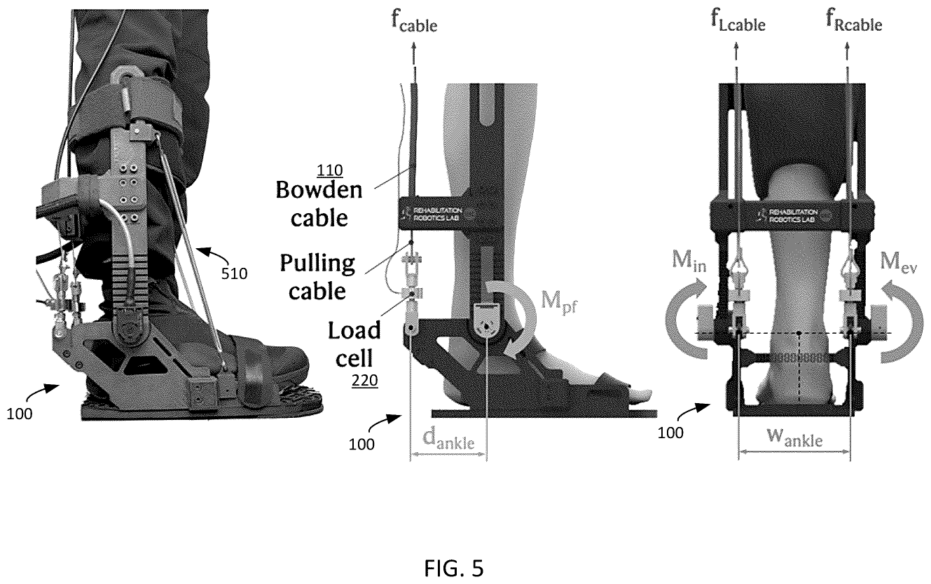

Referring now to FIG. 6, an exemplary personalization framework is comprised of three components: A) human-machine system, B) cost function estimation—to predict user outcomes given assistance, and C) Bayesian optimization—to evaluate cost landscape given assistance and measured costs, and then select the next parameter, where the machine generally operates based on a pre-determined parameter set (e.g., speed, ankle angle, step frequency, parameterized trajectory, etc.). As a non-limiting example, the human-machine system is related to walking and squatting with non-disabled individuals; the cost function estimation is predicted using a physiological or kinematic measure, such as electrocardiogram (ECG) or heart rate data (e.g., via a smartwatch, chest band, ring, ear sensor, etc.), and Bayesian optimization is directed to optimizing assistance parameters by generating a cost landscape (Gaussian process) and determining an optimal assistance parameter. Accordingly, in other contexts and scenarios, different human-machine systems may be used, such as an ankle-foot prosthesis systems involving individuals walking with various amputations (e.g., below knee amputations) using prostheses or auditory command systems for step frequency pacing of non-disabled subjects. Likewise, various cost function estimations may be used, such as, but not limited to, those involving indirect calorimetry or foot contact force measures to evaluate the effectiveness of personalized assistance.

As shown in FIG. 6, the personalization framework starts with the human-machine system. In particular, we aim to optimize the machine parameter to meet each human's needs. As discussed, the machine can be a wearable robot (e.g., robotic ankle-foot prosthesis or robotic ankle-foot orthosis) or commands from a device (e.g., auditory cues). The machine provides assistance, and the human conducts an activity given assistance while interacting with the machine. In this framework, we personalized parameters for an AFO wearable device in an exemplary scenario. Here, a two-degree-of-freedom robotic ankle-foot wearable device 100 with an active plantarflexion and in/eversion is used in accordance with embodiments of the present disclosure. For this example, the AFO wearable device 100 comprises an aluminum frame, two toe plates 214, 216, and a compliant sole 130. The compliant heel of the sole uses a heel fiberglass spring (Gordon Composites, Montrose, CO). The rotation of each shaft-toe assembly resembles the natural dorsiflexion and plantarflexion of an anatomical ankle joint. Two ankle angle sensors 230 mounted to the frame measure the angle for each toe plate's axis, and a load cell 220 is used to measure the actual torque observed. This AFO wearable device 100 provides assistance by providing ankle torque during the stance phase of the gait cycle. The level of assistance is determined using a predefined ankle-torque curve parameterized with stiffness parameters. In various embodiments, this parameter can be personalized iteratively using a foot pressure sensor or respiratory measures.

For cost function estimation, the user outcome given assistance is recorded and used to determine the best assistance for the user. The cost function estimation determines the user's physical effort using physiological signals. One illustrative physiological signal that can be used to quantify the effect of the assistance is indirect calorimetry. This sensor data can be used to estimate the conventional metabolic cost by measuring the breath-by-breath VO2 and VCO2 using a respiratory measure system and calculating the metabolic rate using VO2 and VCO2 based on the Brockway equation. To do so, in an exemplary session, the sensor was calibrated before every session, and respiratory data were monitored using the COSMED Omnia (data collection application and real-time SDK). The metabolic rate is transferred to LSL using a custom python script. Using this real-time metabolic rate, the steady-state metabolic cost can be estimated, via controller hardware or other computing system, using Phase plane estimation (PPE) and Instantaneous Cost Mapping (ICM).

PPE is a fast, data-driven metabolic cost estimation method that transforms the time-series metabolic rate to the phase plane. In this phase plane, the forward difference of the metabolic rate is mapped into the vertical axis, and the metabolic rate is described in the horizontal axis. The steady-state metabolic cost estimate does not change over time; hence, it can be assumed that the steady-state metabolic cost is a point on the horizontal axis where the vertical axis value is zero. The Bayesian Gaussian mixture clustering can be used to cluster the data in the phase plane and estimate each cluster's mean μ and covariance Σ. The Gaussian mixture means and covariance can then be used to estimate the steady state point on the X-axis, as shown in the equation below:

$$steady state = \frac{{\sum }_{k}^{K} {A}_{k}}{{\sum }_{k}^{K} {B}_{k}}$$

where A and B are the regression coefficients for each cluster k given by Σ_{x.y}/Σₓ, and μ_{y}−A·μₓ. This estimation can be performed for each breath.

Instantaneous Cost Mapping (ICM) is another estimation method for HIL optimization. See Felt et al, “Body-In-The-Loop’: Optimizing Device Parameters Using Measures of Instantaneous Energetic Cost, PloS One, 10(8) (2015). The metabolic rate and steady-state metabolic cost are modeled as a mono-exponential model. A discretized version of this method is presented as follows,

$$z ( i + 1 ) = \frac{τ - dt ( i )}{τ} \cdot z ( i ) + \frac{dt ( i )}{τ} \cdot {z}^{*}$$

Here, z(i) is the metabolic rate measured at the time (i), and z* is the steady-state metabolic cost function that needs to be estimated. The dt(i) is the time difference between the breath i and the next breath i+1, and τ is the time constant. τ is initialized in this system as 42 based on the Selinger et al. recommendation, see Selinger et al., “Estimating Instantaneous Energetic Cost During Non-Steady-State Gait,” Journal of Applied Physiology, pp. 1406-1415 December 2014, and is changed based on the activity, as suggested by Witte et al. See Witte et al., “Improving The Energy Economy of Human Running with Powered and Unpowered Ankle Exoskeleton Assistance,” Science Robotics, March 2020.

An additional cost function estimation involves using Electrocardiogram (ECG) measures to determine a user's physical effort and predict metabolic cost. ECG data can be measured using a chest strap and filtered with a real-time filter to obtain R-R (peak in the ECG data) interval differences, where the root mean square of R-R interval differences (RMSSD) to estimate energy expenditure. To calculate the RMSSD in real-time, in various embodiments, the ECG data is filtered using a 0.5 Hz high-pass 5th-order Butterworth filter and any linear drift is removed. The R-R peaks can be identified using the method proposed by Kalidas et al. in “Real-Time QRS Detector Using Stationary Wavelet Transform for Automated ECG analysis,” in 2017 IEEE 17th International Conference on Bioinformatics and Bioengineering (BIBE), IEEE, 2017, pp. 457-461. The time intervals between R-R peaks may then be squared and averaged for a time range, where the square root of the average is used as the cost function.

Further, in some embodiments, the cost estimation function involves foot contact forces since foot contact forces can be used to predict the energy expenditure of walking. The contact forces can be measured using F-scan foot pressure sensors (Tekscan, MI, USA) that are placed over the left and right insole and calibrated using the F-scan step calibration method. In various embodiments, both sensors have 25 sensels per square inch, and pressure information at each sensel is transferred using the USB communication protocol and accessed through a Tekscan API at 120 Hz. Acquisition can be set up using a custom python application to integrate this physiological measure into the exemplary personalization framework. For example, the foot contact force data can be sent to LSL every 1 sec.

Correspondingly, in various embodiments, Foot force time integral (FFTI) estimates the metabolic cost of steady-state walking using gait asymmetry information. For each left and right limb, the control hardware 302 (or other computing device) can calculate the foot contact force applied during walking and integrate it across the stance phase. This value can then be used to calculate the symmetric index (SI) which is used to determine the asymmetric cost and estimate the approximate metabolic cost.

Referring back to FIG. 6, the personalization framework performs Bayesian Optimization (BO) after completion of cost function estimation. Bayesian Optimization (BO) is a process that optimizes a parameter given various cost functions and device parameters. In general, BO is a semi-global, non-parametric, and noise-tolerant method and, typically, involves two sequential optimization steps; the first is the generation of the posterior distribution and the second is sampling the next optimization point using the acquisition function.

In various embodiments, for the first optimization step, a Gaussian process (GP) is used as the posterior function for its sample efficiency, non-parametric, and noise tolerance characteristics. Data and kernel functions are used to estimate the posterior function, with mean and covariance at each point in the sample space.

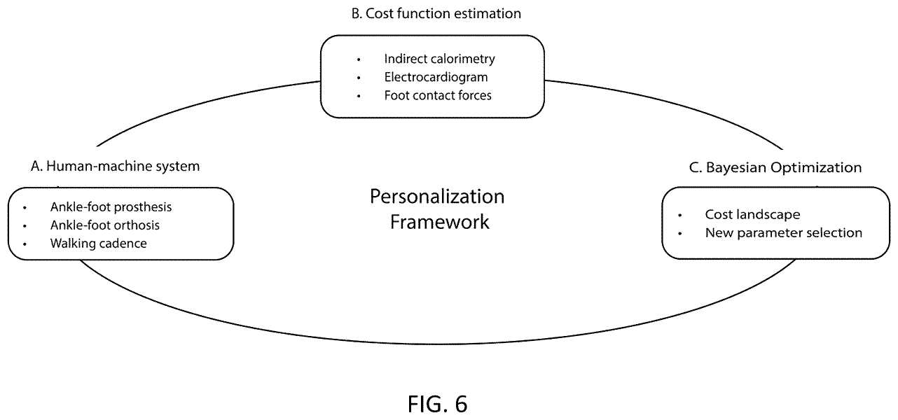

FIG. 7 shows an exemplary Algorithm for the construction of the posterior function's mean and covariance at each point (x_{*}) on the sample space. Here, kₙ is a vector obtained by applying the kernel function (k) on known data points xₙ and sample space x_{*} in the form kₙ=k(xₙ, x_{*}). K is the matrix obtained by applying kernel function (k) on the entire sample space (x_{*}) in the form K=k(x_{*}, x_{*}). The σₙₒᵢₛₑ is a hyper-parameter tuned during the construction of the Gaussian process. In various embodiments, the squared exponential (SE) kernel is used as a standard practice, since it is easy to switch kernels depending on the applications.

For the second optimization step, a new parameter can be selected using the mean and standard deviation of the posterior function while balancing between exploration and exploitation. For example, Expectation of Improvement (EI) can be used as shown in the Acquisition function section of the Algorithm (FIG. 7). The μₓ_{_{*}} and the σₓ_{_{*}} are the mean and standard deviation of the posterior function (Gaussian process) at each point x_{*} in the sampling space. The f_{best}−best output observed with the sampling point is used to construct a matrix (Vₓ_{_{*}}). The matrix calculation depends on the acquisition function (e.g., EI, Probability of improvement (PI), Upper Confidence Bounds (UCB) [54]). The sampling points corresponding to the maximum value are selected as the next points in the optimization loop (argmax (Vx) in the Algorithm). Several other methods, such as noisy EI or Monte Carlo-based functions (e.g., MC-EI), can be used depending on the application.

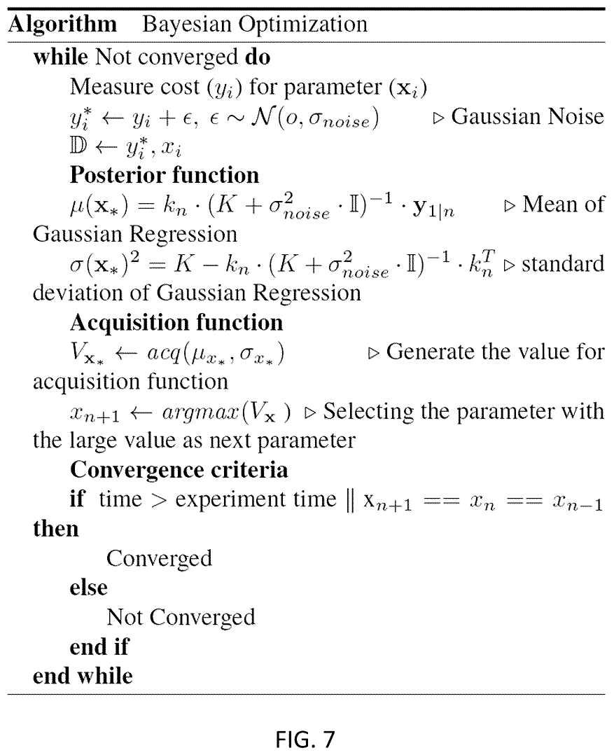

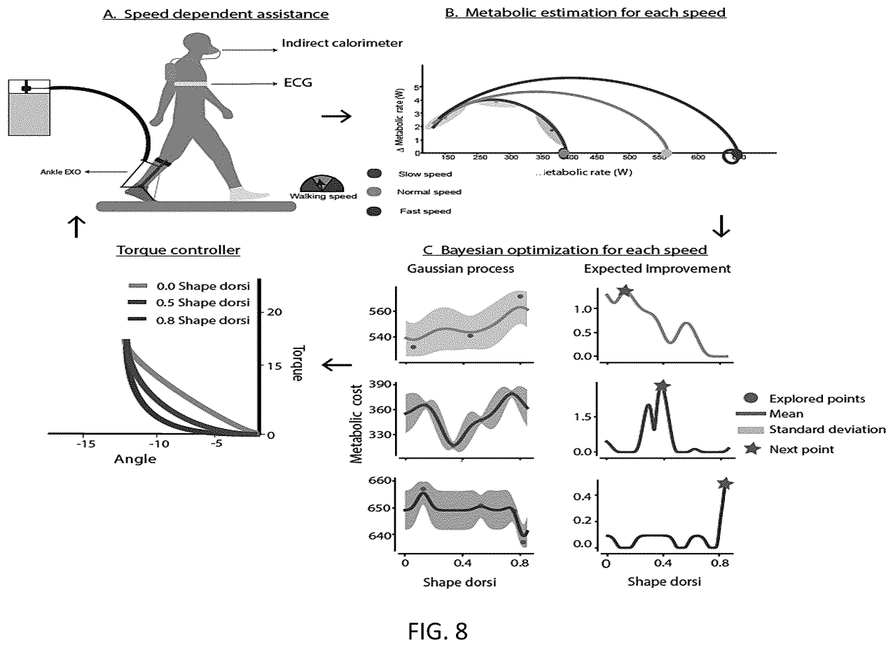

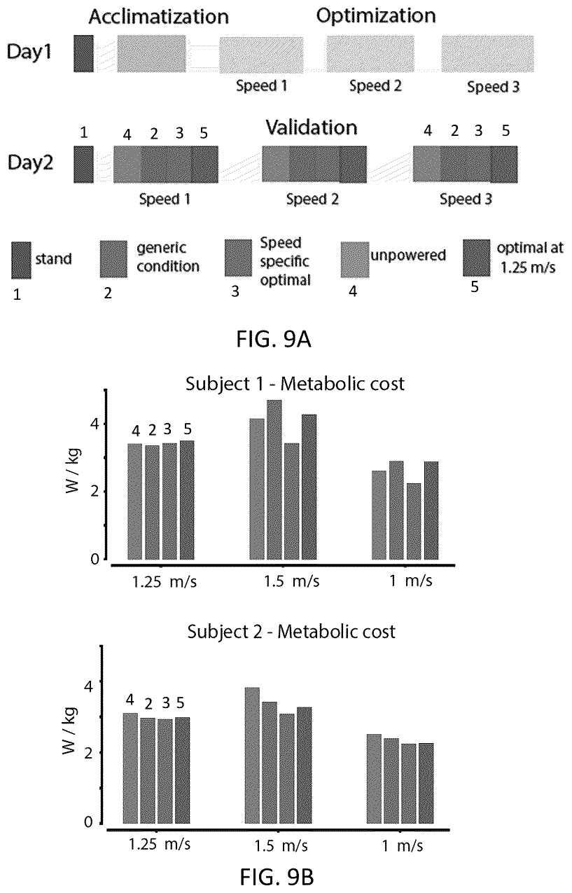

As discussed, the human-machine system component of the personalization framework of FIG. 6 can involve various machine systems that interface or interact with a human. For evaluation purposes, the exemplary personalization framework was tested to personalize AFO assistance. The primary motivation of this case study was to test the feasibility of the personalization framework with various populations. Accordingly, the framework was tested for various activity conditions in non-disabled individuals, as illustrated in FIG. 8, at various speeds (1 m/s, 1.25 m/s, and 1.5 m/s). It is hypothesized that the personalized assistance will be different for different speeds; hence, the framework should work for various activities. We tested by comparing the user outcomes from the speed-specific, personalized assistance condition to the generic and optimal assistance identified at normal walking speed, as illustrated in FIG. 9A, which depicts a two-day protocol used to personalize assistance using the personalization framework.

For this particular study, a 1-degree of freedom (DOF) and tethered ankle exoskeleton was used as part of the human-machine system. However, other machines, such as the AFO wearable device 100 of the present disclosure can also be used in other implementations. The gait cycle of the participating human users were divided into swing and stance phases which were identified using the heel and toe switches integrated into the ankle exoskeleton. During the swing phase, we used a zero position controller so the subject could freely move to the next step. During the stance phase, a low-level control process of a controller hardware device conducted the torque control to track the desired torque, and a high-level control process of the controller generated the desired torque curve based on the ankle angle and a shape-dorsi parameter, as illustrated in FIG. 8 from the BO process (e.g., that can be performed by BO software module executed on the controller hardware or another computing device).

For the cost function component of the personalization framework, the metabolic cost of walking at three different speeds is estimated using the PPE method and respiratory measures.

For the Bayesian Optimization component, optimization is performed for each speed separately using metabolic cost as the cost function. To estimate the cost landscape, we used the GP with SE kernel, and for the acquisition function, we used EI. The shape-dorsi parameter range was 0-0.85 based on subject weight and device control range.

For the testing period, a two-day protocol was used to identify and validate the speed-specific optimal assistance, as illustrated in FIG. 9B, with two subjects (Male, age: 27, 19 years, weight 91, 75 kg, Height 185, 172 cm). The walking speeds for low, medium, and high were 1 m/s, 1.25 m/s, and 1.5 m/s, respectively.

On Day 1, an exoskeleton acclimatization trial was performed at different speeds. During this trial, the subject walked under three different stiffness conditions for 2 min each for low, medium, and high-speed conditions (Order randomized for each subject). After each speed condition, a 7 min rest time was allocated for the subject. Following this acclimatization period, HIL optimization was performed for each speed. Typically, the optimization process took 12 minutes, during which the HIL optimizer software (executed by the controller hardware 302 or other computing device) selected consecutive parameters that indicated the best point. After each optimization, 7 min sitting rest time was provided to the subject.

On Day 2, the optimal control parameters obtained on Day 1 were validated by comparing them with unpowered, generic conditions (fixed stiffness) and optimal conditions for normal speed. Each condition was further divided into three trials of 5 min for each speed. Between each speed trial, 1 minute of sitting rest time was provided. After each condition, 7 minutes of rest time was provided. The order of each condition was randomized to reduce the learning effect.

From the testing trial, it was found that personalized assistance reduced steady-state metabolic cost for speed-specific optimal conditions compared to unpowered conditions. The metabolic costs were reduced by 5.8% and 18.8% for 1.5 m/s speed for subjects 1 and 2, respectively. Each participant reduced the metabolic cost of walking by 1.8% and 2.0% for the speed-specific optimal condition compared to the unpowered condition at 1.25 m/s. They also reduced the cost by 0.5% and 20.8% for the 1 m/s condition, respectively. On average, personalization took seven parameters and 820 seconds, including the warm-up period. Compared to generic and normal speed's optimal conditions, for each speed, it was observed that speed-specific optimal conditions reduced metabolic costs for all other conditions.

In the above scenario, the personalized assistance reduced the metabolic cost compared to generic or control-off conditions. These results indicate that the personalization framework can be used to personalize assistance while accommodating diverse population-machine systems, cost functions, and BO variants. The framework application can be applied to a variety of scenarios, such as but not limited to: assisted squatting activity with non-disabled and robotic AFO system, utilizing metabolic cost estimation and a regular BO; and assisting walking with individuals who had a simulated amputation using robotic AFP, physical effort estimation using foot contact forces, and regular BO. In addition, the disclosed modular framework is lightweight, parallelized, and compatible with mobile computers, presenting opportunities to perform optimization in outdoor settings.

When the personalization framework has been used to personalize assistance for individuals with transtibial amputation, the personalized assistance resulted in a maximum of 5.6% and 18.1% reductions for two subjects, respectively, compared to the generic condition. Given that personalizing ankle-foot prostheses has been challenging, perhaps in part due to reduced strength for individuals with reduced mobilities, the extensive optimization time can induce fatigue and potentially subsequently lead to unsuccessful optimization. However, by incorporating a rapid metabolic cost estimation method coupled with a sample-efficient Bayesian Optimization (BO) module for HIL optimization in accordance with various embodiments of the present disclosure, this combination effectively trims the total optimization time down to a mere 12 minutes, which is a threefold speed increase compared to the conventional Human-In-The-Loop (HIL) optimization method that relies on Covariance matrix adaptation evolution strategy (CMAES). The faster optimization may have contributed to identifying better-personalized assistance as it could minimize long optimization-induced fatigue.

When the personalization framework has been used for step frequency (walking cadence) optimization, where a subject is instructed to follow a metronome-set walking cadence, the personalization and modular framework successfully identified optimal frequency through the use of different cost function modules (ECG and respiratory measures) and BO modules (Respiratory: GP for cost landscape and EI for the acquisition function; ECG: GP for cost landscape and EI & MC-EI for acquisition). Especially when an ECG-based cost estimation module was used, the optimal step frequency was identified 43% faster than a respiratory-based cost estimation method, including PPE. Also, regardless of the BO module variants on the parameter selection method, the optimal point was found in 5 iterations. The ECG-based cost estimation also has additional advantages in terms of portability and wearer comfort, making it a desirable alternative to indirect calorimetry, which relies on face masks, and it may help to optimize assistance in a natural setting.

As described with respect to FIG. 8, when the personalization framework has been used for speed-specific personalized assistance, the personalized assistance using this framework was found to reduce the metabolic cost by an average of 7.8% under speed-specific conditions compared to the generic assistance condition, indicating that this framework can be applied to various walking speeds. Furthermore, the optimization process took only 12 minutes, which is one-third of the time required by state-of-the-art methods for three different walking speeds. Recent studies have emphasized the importance of personalized assistance in natural settings, and these fast and adaptable optimization results can be useful for providing personalized assistance in the outdoor environment.

By keeping the optimization algorithm constant while allowing for easy integration of different cost functions, the personalization framework can help benchmark exoskeleton performance and personalize wearable robots for various populations. Additionally, the modular configuration of the framework allows for expansion and the ability to test multiple optimizations simultaneously in parallel. The results from case studies demonstrate that the framework is applicable for multiple populations, assistive devices, cost functions, and optimization setups. Overall, this framework has the potential to lower the barrier of entry for personalizing wearable robots and help further advance their performance.

Thus, as discussed, the present disclosure provides systems and methods for a personalization framework for wearable robots that enhances user outcomes such as energy efficiency, user comfort, or symmetry through human-in-the-loop Bayesian optimization. An exemplary framework utilizes physiological feedback, such as hear rate, muscle activity, and foot pressure from the user to dynamically adjust the robot's parameters. This framework is applicable to the presented device as well as other wearable robots including a robotic ankle-foot prosthesis. Key components include modular cost functions and optimization algorithms tailored to user-specific physiological responses.

Next, FIG. 10 depicts a schematic block diagram of a computing device 1000 that can be used to implement various embodiments of the present disclosure, such as the controller hardware 302 or other computing device (e.g., a computing device performing cost function estimation and/or Bayesian optimization operations related to the personalization framework of FIG. 6). An exemplary computing device 1000 includes at least one processor circuit, for example, having a processor 1002 and a memory 1004, both of which are coupled to a local interface 1006, and one or more input and output (I/O) devices 1008. The local interface 1006 may comprise, for example, a data bus with an accompanying address/control bus or other bus structure as can be appreciated. The computing device 1000 further may include Graphical Processing Unit(s) (GPU) 1010 that are coupled to the local interface 1006 and may utilize memory 1004 and/or may have its own dedicated memory. The CPU and/or GPU(s) can perform various operations such as generating and sending assistance control commands for an AFO wearable device 100 and/or personalizing control parameters related to training regimens for such assistive device, and any of the various operations described herein.

Stored in the memory 1004 are both data and several components that are executable by the processor 1002. For example, in various embodiments, stored in the memory 1004 and executable by the processor 1002 may be code 1012 for determining assistance control parameters and generating actuation commands based on such parameters, as disclosed herein. Also stored in the memory 1004 may be a data store 1014 and other data as disclosed herein. In addition, an operating system may be stored in the memory 1004 and executable by the processor 1002. The I/O devices 1008 may include input devices, for example but not limited to, a keyboard, mouse, etc. Furthermore, the I/O devices 1008 may also include output devices, for example but not limited to, a printer, display, etc.

Certain embodiments or embodiment components of the present disclosure can be implemented in hardware, software, firmware, or a combination thereof. If implemented in software, such embodiments can be implemented in software or firmware that is stored in a memory and that is executed by a suitable instruction execution system. If implemented in hardware, such embodiments or embodiment components can be implemented with any or a combination of the following technologies, which are all well known in the art: discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

It should be emphasized that the above-described embodiments are merely possible examples of implementations, merely set forth for a clear understanding of the principles of the present disclosure. Many variations and modifications may be made to the above-described embodiment(s) without departing substantially from the principles of the present disclosure. For example, in various embodiments, the personalization framework can include optimization algorithms to address time-varying dynamics, such as time-dependent BO algorithms. All such modifications and variations are intended to be included herein within the scope of this disclosure.

Therefore, at least the following is claimed:

1. An orthosis system comprising:
an ankle-foot orthosis wearable device having a split-toe plate design comprising dual unidirectional actuation, wherein the split-toe plate design comprises a left toe plate and a right toe plate, wherein each of the left toe plate and the right toe plate is integrated with an ankle angle sensor that is configured to detect a position of the respective toe plate, wherein each of the left toe plate is further integrated with a load cell sensor that is configured to measure a torque being applied to the respective toe plate;
an off-board actuator system configured to independently move or rotate the left and right toe plates, wherein the off-board actuator system is in mechanical communication with the ankle-foot orthosis wearable device via one or more mechanical cables; and
at least one controller hardware device configured to:
deliver control and sensor signals to the off-board actuator system, wherein the at least one controller hardware device is in electrical communication with the ankle-foot orthosis wearable device; and
correct at least one of plantarflexion or inversion-eversion torque of a human ankle in real time during an activity session based on activity skill levels analyzed via the at least one controller hardware device and data received from the ankle angle sensors or the load cell sensors at an earlier time.

2. The system of claim 1, wherein the ankle-foot orthosis wearable device comprises a hybrid material of rigid metal and soft rubber and/or a compliant material comprising carbon fiber reinforced nylon.

3. The system of claim 1, wherein the at least one controller hardware device performs a mid-level control routine to generate a desired-torque curve proportional to an ankle angle or based on a stance phase and a low-level control routine to generate control signals comprising a desired motor velocity.

4. The system of claim 1, wherein the at least one controller hardware device is configured to obtain real-time physiological or biomechanical data of a user of the ankle-foot orthosis wearable device during an exercise activity involving the ankle-foot orthosis wearable device and is configured to optimize a control parameter of the ankle-foot orthosis wearable device using the real-time physiological or biomechanical data.

5. The system of claim 4, wherein the physiological data comprise heart rate data or electrocardiogram or muscle activity data of the user.

6. The system of claim 4, wherein the physiological data comprise respiratory data.

7. The system of claim 4, wherein the ankle-foot orthosis wearable device comprises a foot pressure sensor integrated on a left and right insole of the ankle-foot orthosis wearable device, wherein the physiological data comprise foot contact forces obtained from the foot pressure sensors.

8. The system of claim 4, wherein the control parameter comprises a torque force to be applied to the ankle-foot orthosis wearable device by the at least one controller hardware device and the off-board actuator system.

9. The system of claim 4, wherein the control parameter comprises a speed to be applied to a treadmill of the user.

10. The system of claim 4, wherein the control parameter comprises an ankle-angle to be applied for a left toe plate or a right toe plate by the off-board actuator system.

11. The system of claim 10, wherein the at least one controller hardware device is configured generate a torque curve, wherein the control parameter comprising the ankle-angle is proportional to the torque curve.

12. The system of claim 4, wherein off-board actuator system comprises two independent cable-pulling transmissions driven by electric motors attached to the ankle-foot orthosis wearable device, wherein the control parameter comprises a motor velocity for the off-board actuator system.

13. The system of claim 1, wherein the control signals are based on a predetermined control parameter set and at least one of the control parameters in the predetermined control parameter set is personalize to a user using physiological or biofeedback responses during one or more physical activities using the ankle-foot orthosis wearable device.

14. A method comprising:
physically coupling an off-board actuator system to an ankle-foot orthosis wearable device, wherein the off-board actuator system is configured to independently move or rotate an exoskeleton frame of the ankle-foot orthosis wearable device as it is being worn by a user, wherein the off-board actuator system is in mechanical communication with the ankle-foot orthosis wearable device via one or more mechanical cables;
delivering, via at least one controller hardware device, control signals to the off-board actuator system, wherein the at least one controller hardware device is in electrical communication with the ankle-foot orthosis wearable device; and
correcting, via the at least one controller hardware device, at least one of plantarflexion or inversion-eversion torque of a human ankle of the user in real time during an activity session based on activity skill levels analyzed via the at least one controller hardware device and data received from ankle angle sensors or load cell sensors that are integrated in the exoskeleton frame at an earlier time.

15. The method of claim 14, further comprising:
performing, via the at least one controller hardware device, a mid-level control routine to generate a torque curve proportional to an ankle angle or torque based on stance period and a low-level control routine to generate control signals comprising a desired motor velocity.

16. The method of claim 14, further comprising:
obtaining, via the at least one controller hardware device, real-time physiological data of the user of the ankle-foot orthosis wearable device during an exercise activity involving the ankle-foot orthosis wearable device; and
optimizing, via the at least one controller hardware device, a control parameter of the ankle-foot orthosis wearable device using the real-time physiological data.

17. The method of claim 16, wherein the physiological data comprise heart rate data, electrocardiogram data, muscle activity, or respiratory data of the user.

18. The method of claim 16, wherein the ankle-foot orthosis wearable device comprises a foot pressure sensor integrated on a left and right insole of the ankle-foot orthosis wearable device, wherein the physiological data comprise foot contact forces obtained from the foot pressure sensors.

19. The method of claim 16, wherein the control parameter comprises a torque force to be applied to the ankle-foot orthosis wearable device by the at least one controller hardware device and the off-board actuator system, a speed to be applied to a treadmill of the user, an ankle angle to be applied for a left toe plate or a right toe plate by the off-board actuator system, or a motor velocity for the off-board actuator system.

20. The method of claim 14, wherein the control signals are based on a predetermined control parameter set and at least one of the control parameters in the predetermined control parameter set is personalize to a user using physiological or biofeedback responses during one or more physical activities using the ankle-foot orthosis wearable device.
